(19) United States
(12) Patent Application Publication
(10) Pub. No.: US 2023/0283063 A1
(43) Pub. Date: Sep. 7, 2023

(54) SYSTEMS AND METHODS OF CIRCUIT PROTECTION

(71) Applicant: DRG TECHNICAL SOLUTIONS, LLC, Memphis, TN (US)

(72) Inventors: Travis SMITH, Memphis, TN (US); Michael MARSHALL, Memphis, TN (US)

(21) Appl. No.: 17/684,621

(22) Filed: Mar. 2, 2022

(51) Int. Cl. H02H 3/08; H02H 3/20

(52) U.S. Cl. CPC H02H 3/08; H02H 3/20

(57) ABSTRACT

This disclosure provides a novel framework that enables cost-effective, accurate and scalable detection, prediction, and mitigation of component failure or non-nominal operation in a power system. According to an embodiment, a computing device may implement a power system model that reflects the behavior, performance characteristics, and/or operational state of components in a power system. The computing device may create the power system model using historical and real-time data. The computing device may include a sensing module designed to determine at least one performance characteristic of a component of a power system; a processing module configured to apply a power system model to the at least one characteristic to determine at least one operational state of the component; and a control module configured to effect a change in a component of the power system in response to the at least one operational state.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE DISCLOSURE

The present disclosure relates generally to improving the performance of power systems by modifying the capabilities of and providing non-native functionality to devices, systems and/or platforms through a novel and improved framework for developing and training generative power system models and applying them to real-time data sources.

### BACKGROUND

The methodologies and equipment protecting current power systems, ranging from residential to generation facilities, have remained mostly unchanged since the 20th century. While these methods are still mostly effective, the increase in new dispersed inverter-based generation sources have significantly decreased the reliability, selectivity, sensitivity, and security of these methods. Increasingly, trends in power system development skew towards circuits and sections of the power grid that are able to disconnect from the greater system and “island”, with only inverter-based distributed energy resources (e.g., microgrids). However, current protection systems and settings were not designed to handle a new reconfiguration of the grid and will not function properly when islanded. Utility companies have attempted to address changes in the configuration of the grid with additional protective settings intended to cover a broader spectrum of scenarios. Still, inverter-based distributed energy resources present new issues that are not addressed by these additional protective settings.

### BRIEF SUMMARY

This disclosure provides a novel framework that alleviates shortcomings in the art, and provides systems and methods for performing cost-effective, accurate and scalable detection, prediction, and mitigation of component failure or non-nominal operation in a power system. Systems and methods discussed herein allow for incorporation of future protection systems and hybrid upgrades to legacy systems in order to harden existing power system and allow for integration of more inverter-based power system components while addressing safety, fire prevention, security, reliability, adaptability and resiliency of the protection systems.

According to an embodiment, a protection system and related computing devices are provided to enable the appropriate level of reliability, selectivity, sensitivity, security, and adaptability in the protection posture required by modern and future power systems integrated with inverter-based generating resources. As will be noted, embodiments described herein are applicable to power systems in general including residential, commercial, industrial, military, distribution, and transmission applications. In some embodiment, a protection system may include computing devices, as well as sensing modules and control modules.

According to an embodiment, computing devices disclosed herein incorporate modeling, sensing, and protection algorithms for fault detection and isolation including artificial intelligence (AI) and machine learning (ML) techniques that future-proof power systems by providing cyber awareness, new control methods, new protection methodologies, and automated testing. In some embodiments, computing devices contemplated herein include communication with or integration of supercomputers capable of large-scale calculation on large datasets (e.g., the Summit Supercomputer developed by IBM®). In some embodiments, computing devices contemplated herein include communication with or integration of a low-cost, low-power “off-the-shelf” supercomputer similar to the open-source Tiny Titan supercomputer developed by the Oak Ridge National Laboratory.

According to some embodiments, computing devices disclosed herein may form part of a power systems. In some embodiments, the power system also includes grid-sources, inverters, wiring, loads, shunt-trip breakers, disconnects, and sensors (including voltage/current meters, current transformers, potential transformers, cameras, microphones, transducers, and the like). In some embodiments, the computing device may be connected to sensing modules (e.g., sensors) and control modules corresponding to discrete components of the power system. In some embodiments, a power system may include one or multiple computing devices. In some embodiments, where the power system includes multiple computing devices, the computing devices may coordinate directly or over a network(s) to act as a single device or system.

According to an embodiment, computing devices disclosed herein can create and implement a power system model that reflects the behavior, performance characteristics, and/or operational state of components in a power system (e.g., power system 100 as discussed in reference to FIG. 1). In some embodiments, the power system model includes some or all of the components connected to a power grid. In some embodiments, the power system model includes some or all of the components connected to a residential or commercial electrical system. The computing device may create the power system model using data received from sensors, modules, and other data sources. In some embodiments, the computing device may use historical data and real-time data to create and update the model. The computing device may continuously update the power system model as new data is received or as components are added or removed from the power system. In some embodiments, computing device creates the power system model prior to runtime. In some embodiments, computing device uses a generic power system model as a starting point, and creates a specific or trained power system model using the historical data. During runtime, the computing device may update the power system model as new data is received.

In some embodiments, the computing device can dynamically provide data received from the several modules to the power system model to adjust protection settings and make appropriate control decisions for the components in real-time. In some embodiments, the power system model can determine changes in or distinguish between different disturbances in the power system, such as a fault or a magnetizing inrush. In some embodiments, the computing device can use the power system model to determine a performance characteristic or operational state of a component without communicating or monitoring the component. In some embodiment, the computing device can use the power system model to predict a present or future performance characteristic or operational state. In some embodiment, the power system model to allows the computing device to protect power system components upstream or downstream from the computing device 200.

An aspect of the present disclosure is a method for creating or training a power system model using training data corresponding to power systems in general to create a trained power system model. The power system model may then be used to determine failures or non-nominal operation of components of the power system. In some embodiments, the power system model receives real-time data from different sources and applies the trained power system model to the received data. The trained power system model can determine failures or non-nominal operation of components that traditional detection and protection methods may not be able to detect (e.g., in inverter-based systems).

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a power system within which the systems and methods disclosed herein could be implemented according to some embodiments of the present disclosure;

FIG. 2 is a schematic diagram illustrating an example of a computing device in accordance with some embodiments of the present disclosure;

FIG. 3 is a block diagram illustrating components of an exemplary system in accordance with embodiments of the present disclosure; and

FIG. 4 illustrates non-limiting example embodiments of a data flow for performing accurate and scalable detection, prediction, and mitigation of component failure or non-nominal operation in a power system according to some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4th or 5th generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

The detailed description provided herein is not intended as an extensive or detailed discussion of known concepts, and as such, details that are known generally to those of ordinary skill in the relevant art may have been omitted or may be handled in summary fashion. Certain embodiments will now be described in greater detail with reference to the figures.

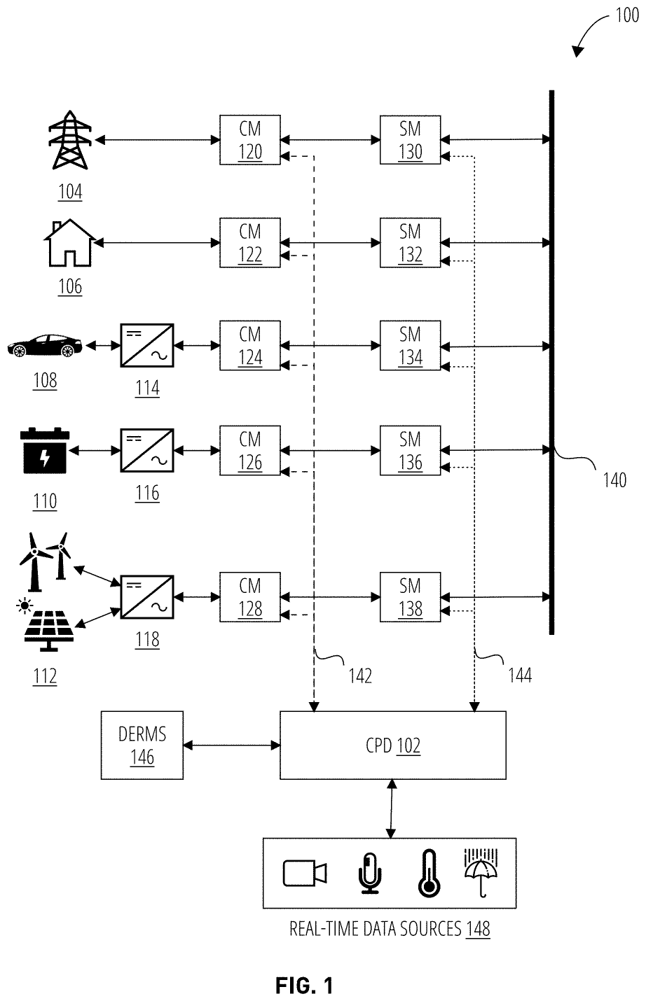

Referring now to FIG. 1, a power system 100 in accordance with an embodiment of the present disclosure is shown. FIG. 1 shows components of a general power distribution environment in which the systems and methods discussed herein may be practiced. Not all the components may be required to practice the disclosure, and variations in the arrangement and type of the components may be made without departing from the spirit or scope of the disclosure.

According to an embodiment, the power system 100 may be a grid-level power electrical distribution and transmission system. The power system 100 may include a multitude of components, for example, power sources 104, loads 106, electric vehicles 108, battery storage systems 110, and renewable power sources 112 connected to a grid 140. In some embodiments, at least some of the components of the power system 100 may be connected to the grid 140 using inverters, for example, inverters 114-116. It will be understood that in that sense, inverters 114-116 are also components of power system 100. For example, electric vehicles 108 may form part of an electric vehicle fleet that draws power from the grid 140 to charge the vehicle and can provide power to the grid 140 when needed. In some embodiments, electric vehicle 108 is connected to the grid 140 using vehicle-to-grid inverter 114. Similarly, in some embodiments, battery storage system 110 and renewable power source 112 may be connected to the grid 140 through inverters 116 and 118, respectively. It will be understood that inverters 114-118 may be of varying size depending on their application.

As will be noted, systems and methods discussed herein may be scaled for different applications. For example, in some embodiments, the power system 100 may be a commercial or residential level electrical system. Accordingly, grid 140 may be the electrical system of a residential or commercial property where power source 104 may be the electrical service provided to the property and load 106 may be traditional loads found on a residential or commercial property (e.g., appliances, lights, electronics, HVAC, and machinery). In some embodiments, an electric vehicle 108 may be connected to the grid 140 through a vehicle-to-grid inverter 114 to draw power when charging or to provide power to the property when needed. In another embodiment, a battery storage system 110 may be a residential battery backup system (e.g., Tesla® Powerwall®) connected to the grid 140 through a battery-backup inverter 114. In some embodiments, the renewable power source 112 may be solar panels and/or wind turbines connected to the grid 140 through an inverter 118. In some embodiments, some or all of the inverters 114-118 may be combined into one system. Still, embodiments described herein may also be implemented or form part of power distributions environments in aircraft, watercraft, and automobiles.

According to an embodiment, access or connection of discrete components to the grid may be controlled by a circuit protection device in direct communication with the component, through control modules, or a combination of both. In some embodiments, the circuit protection device can directly control the inverters of components that use inverters to connect to the grid. In some embodiments, the circuit protection device may monitor performance characteristics or operational state of a component through data directly provided by the component or by using sensing modules. In some embodiments, the sensing modules can be directly connected to the component. In some embodiments, the sensing modules can monitor the connection between the component and the grid.

Returning to FIG. 1, as shown, in some embodiments, a circuit protection device 102 may connect to or communicate with control modules 120-128 and sensing modules 130-138 through communication links 142 and 144, respectively. It will be noted that FIG. 1 shows but one arrangement of the power system 100 and, therefore, the arrangement and location of the components and modules is non-limiting. In some embodiments, circuit protection device 102 may be connected to each control module or sensing module either through a direct connection or through a network (as described elsewhere herein), or a combination thereof. In some embodiments, some control/sensing modules may be local to circuit protection device 102 while others may be remote. In some embodiments, some modules may be local when implemented in the same physical location or in the same device, while some modules may be remote when implemented in a separate physical location or in another device.

According to some embodiments, the circuit protection device 102 may connect to or communicate with control modules 120-128 to control a component of the power system 100. In some embodiments, control modules 120-128 allow the circuit protection device 102 to control a portion of the component. In some embodiments, control modules 120-128 allow the circuit protection device 102 to modify or alter a performance characteristic or operational state of a component. In some embodiments, control modules 120-128 allow the circuit protection device 102 to effect a change in the component to alter or modify a performance characteristic or operational state of the component. In some embodiments, control modules 120-128 allow the circuit protection device 102 to effect a change in at least one component in order to alter or modify a performance characteristic or operational state of another component. In some embodiments, control modules 120-128 may include power controls elements such as circuit breakers, switchgear, reclosers, disconnects, interrupters, tap changers, circuit switchers, switches, and the like. In some embodiments, circuit protection device 102 may be connected to multiple control modules related to a component. For example, circuit protection device 102 may be connected to the renewable power source 112, the inverter 118, and/or control the connection between the two and the grid 140. In that sense, circuit protection device 102 may use multiple control modules 128 to control aspects of the renewable power source 112, the inverter 118, and/or control the connection between the two and the grid 140. In some embodiments, circuit protection device 102 may communicate with the control modules and/or the components directly, through a network, or a combination thereof. In some embodiments, In some embodiments, circuit protection device 102 directs control modules 120-128 to effect a change on performance characteristic of a component by, for example, increasing or decreasing voltage, current, cycles, and speed. In some embodiments, circuit protection device 102 directs control modules 120-128 to effect a change on performance characteristic of a component by, for example, disconnecting a breaker or other switch to isolate a component from other components.

According to some embodiment, sensing modules 130-138 provide the circuit protection device 102 with data relating to the performance characteristics (e.g., voltage, current, load, temperature, cycles, non-simultaneity of breaker poles, inputs, outputs) and operational state (e.g., non-nominal operation, failure, overload, underload, short circuit, overheating) of a component or a portion of a component. In some embodiments, sensing modules 130-138 may include voltage sensors, current sensors, and temperature sensors. In some embodiments, voltage and current sensors may use sensing techniques using traditional iron cores, Rogowski coils, or optical sensors. However, it will be understood that there are numerous types of sensors and any may be used without departing from the spirit or scope of the disclosure. The present disclosure contemplates sensing modules including or comprising any sensing system, method, or technique, whether known or to be known, used in the monitoring of the performance characteristics and operational state of electrical and/or electronic equipment, without departing from the scope of the present disclosure.

In some embodiments, circuit protection device 102 may be connected to or communicate with multiple sensing modules related to a component and different sensing modules may provide data corresponding to different performance characteristics and operational states. For example, circuit protection device 102 may be connected to the battery storage system 110, the inverter 116, and the connection between the two and the grid 140. In some embodiments, circuit protection device 102 may communicate with the control modules and/or the components directly, through a network, or a combination thereof.

According to some embodiments, the circuit protection device 102 may also receive data from real-time data sources 148 to gain real time situation awareness of the power system 100. According to some embodiments, real-time data sources 148 can include images and video from imaging systems (e.g., visible, infrared, or thermal), acoustic (e.g., sounds or mechanical waves), environmental (e.g., weather), and observational/anecdotal from human sources (e.g., power outage reports). In some embodiments, real-time data sources 148 can include data from third party sources. In some embodiments, other types of data may be used. In some embodiments, circuit protection device 102 may receive information gathered from social media (e.g., Twitter®, Waze®, Facebook®, and like) related to power system 100. In some embodiments, intermittent or loss of communication with a component is indicative of a non-nominal component operation.

According to some embodiments, the power system 100 may include a distributed energy resource management system (DERMS) 146 to manage or control components of the power system 100. In some embodiments, the circuit protection device 102 may communicate with DERMS 146 to receive data related to the components of the power system 100. In some embodiments, the circuit protection device 102 may communicate with DERMS 146 to control the components of the power system 100.

As will be discussed in further detail below, in some embodiments, the circuit protection device 102 receives and analyzes the data from the several modules and data sources to determine deviations from nominal performance (e.g., abnormal performance characteristics or unexpected changes in operational state). In some embodiments, determining deviations from nominal performance includes detecting faults, failures, and non-nominal performance. In some embodiments, determining deviations from nominal performance includes inferring faults, failures, and non-nominal performance. In some embodiments, determining deviations from nominal performance includes predicting faults, failures, and non-nominal performance. In some embodiments, the circuit protection device 102 may act through the control modules 120-128 or directly on the components to prevent damage to a specific component or components. In some embodiments, the circuit protection device 102 may act to isolate a faulty or damaged component from the grid 140 or some other component. In some embodiments, the circuit protection device 102 may direct any given component to alter or modify component settings and operation to achieve a desired performance characteristic or operational state.

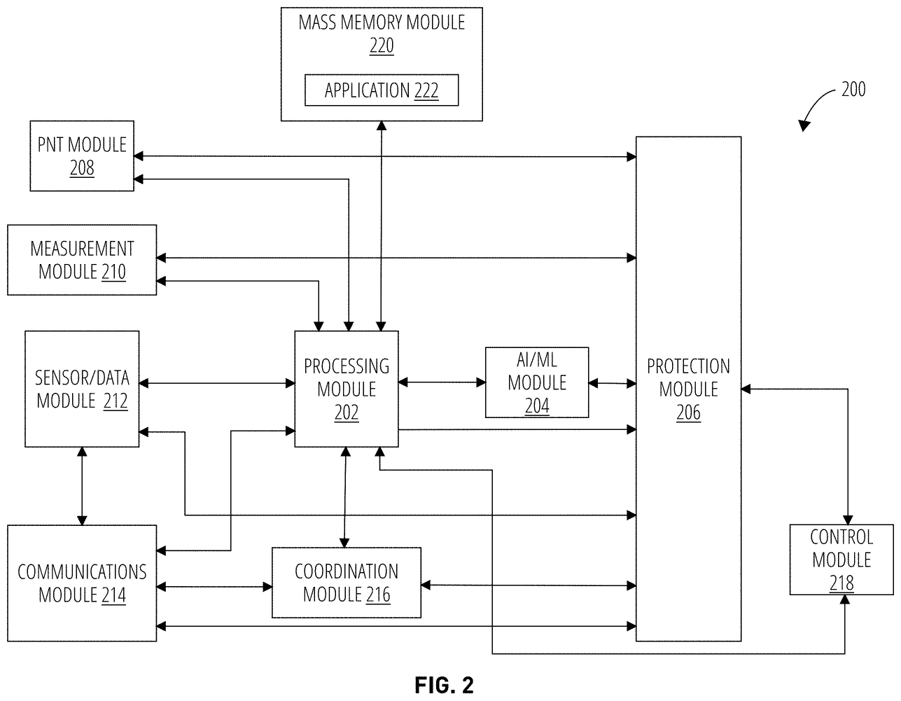

Referring now to FIG. 2, a schematic diagram illustrating an example embodiment of a computing device 200 that may be used within the present disclosure is shown. Computing device 200 may include many more or less components than those shown in FIG. 2. However, the components shown are sufficient to disclose an illustrative embodiment for implementing the present disclosure. Computing device 200 may represent, for example, circuit protection device 102 discussed above in relation to FIG. 1.

As shown in the figure, computing device 200 includes a processing module 202 in communication with an artificial intelligence/machine learning (ML) module 204, and protection module 206. Computing device 200 can include positioning, navigation, and timing (PNT) module 208, a measurement module 210, a sensor/data module 212, a communications module 214, a coordination module 216, a control module 218, and a mass memory module 220. It will be understood that FIG. 2 shows only but one arrangement of computing device 200 and that many more arrangements may be used without departing from the present disclosure. In some embodiments, some or all of the modules of computing device 200 may communicate with each other through a bus or a plurality of busses.

According to an embodiment, the processing module 202 processes and analyzes data from the several modules. The processing module 202 can provide the received data to the AI/ML module 204. The AI/ML module 204 can use the received data to train or update the power system model. The AI/ML module 204 can also use the received data to detect failing or defective components of the power system. In some embodiments, if the power system model determines a failure or non-nominal operation the processing module 202 and/or the AI/ML module 204 can communicate with the protection module 206 to determine the appropriate corrective action to be taken. For example, if the power system model detects an overload condition at an inverter connected to a solar panel system, processing module 202 and AI/ML module 204 may communicates the potential failure to protection module 206. In turn, protection module 206 can determine which components to disconnect or isolate in order to correct the overload. In some embodiments, the protection module 206 may also direct the solar panel array to bring other panels online to provide more power. In some embodiments, the protection module 206 may control a component using the control module 218. In some embodiments, the control module 218 may be a control module (e.g., control modules 120-128) as described with respect to FIG. 1. In some embodiments, the control module 218 may be an interface to interruption devices (e.g., breakers, switches, disconnects) associated with discrete components of the power system.

As noted above, a power system model may be an artificial intelligence model (e.g., a machine learning model). In some embodiments, a power system model is a machine learning model that can include long short-term memory (LSTM) network(s), recurrent neural network(s) (RNN), convolutional neural network(s) (CNN), and the like. In some embodiments, a power system model can include one or more one-class classification model (e.g, one-class support vector machine (SVM), isolation forest, and the like), multi-class/multi-label classification models (e.g., logistic regression, neural networks, decision tree, random forests, and the like), binary classification models (e.g, two-class support vector machine, two-class averaged perceptron, two-class logistic regression, and the like), regression models (e.g., forest quantile, logistic, linear, K-means, Poisson, and the like), or a combination thereof. In some embodiments, a power system model can include an AlphaGo model, a Markov decision model, a QLearning model, a Naïve Bayes model, a Apriori Algorithm model, a kNN model, a dimensionality reduction model; and a gradient boosting models (e.g., gradient boosting machine (GBM), XGBoost, Light GBM, CatBoost, and the like). In some embodiments, the action prediction model may be a supervised learning model, an unsupervised learning model, and a reinforcement-based learning model. In some embodiments, a power system model may use any known or yet to be known machine learning model, network architecture, algorithm, or technique used for predicting an action from a set of input data without departing from the present disclosure.

In some embodiments, the action prediction model may be implemented using TensorFlow, Keras, PyTorch and the like.

In some embodiments, the power system model may include different sub-models to analyze different types of data in an initial step and additional models to analyze the extracted features. According to some embodiments, a power system model may have one or more feature extraction models feeding a main prediction model. In some embodiments, for example, data from images and video may be provided to an image classifier model to determine whether an item in an image is a component of a power system. In turn, the image classifier model may generate a first feature vector model. In some embodiments, the same image may be provided to an optical character recognition model to analyze text from the component to determine performance data regarding the component (e.g., from a component data tag) and generate a second feature vector model. In some embodiments, the first feature vector model and the second feature vector model may be combined to generate an input vector to a main prediction model (e.g., a neural network having one or more hidden layers). In some embodiments, where the main prediction model is a multi-class classifier, the output from the hidden layers may be used to generate a prediction on the type of component and the performance characteristics.

According to an embodiment, computing device 200 may use any of the modules 208-218 to determine failures or non-nominal operation and control the components of a power system. In some embodiments, the PNT module 208 provides positioning and timing data to the processing module 202. PNT module 208 may be a GPS transceiver that can determine the physical coordinates of computing device 200 on the surface of the Earth, which typically outputs a location as latitude and longitude values. PNT module 208 can also employ other geo-positioning mechanisms, including, but not limited to, triangulation, assisted GPS (AGPS), E-OTD, CI, SAI, ETA, BSS or the like, to further determine the physical location of computing device 200. In one embodiment, however, computing device 200 may, through other components (e.g., communications module 214), provide other information that may be employed to determine a physical location of the device, including for example, a MAC address, Internet Protocol (IP) address, or the like. In some embodiments, the PNT module 208 may act as a transceiver and work with communications module 214 to provide satellite communications with the computing device 200.

In some embodiments, the measurement module 210 allows the computing device 200 to make different measurements depending on the particular implementation (e.g., voltage, current, frequency, temperature). In an embodiment, the measurement module 210 is an autoranging measuring system that can dynamically readjust the measurement range in response to large variations of the metric being measured (e.g., low voltage v. high voltage). In some embodiments, measurement module 210 can detect high range short circuit currents and low range short circuit currents (and same for voltage measurements), by, for example, autoranging and comparison of relay class and metering class current (and voltage) transformers. In some embodiments, measurement module 210 allows the computing device 200 real time sensing of synchronous component contributions as well as inverter-based component contributions to the power system with appropriate range and accuracy for protection and control during dynamic operational states. In some embodiments, measurement module 210 may be a sensing module as described with respect to FIG. 1 (e.g., sensing modules 130-138). In some embodiments, measurement module 210 allows for performance characteristic measurements (e.g., voltage, current) on the source and load side of a breaker.

In some embodiments, sensor/data module 212 receives information from other sensors and provides it to processing module 202. In some embodiments, sensor/data module 212 receives information in the form of low-level raw data, sensor/data module 212 may then process and analyze the data to provide the processing module 202 with a high-level interpretation. In some embodiments, a portion or all of the sensor/data module 212 may be implemented on an application specific integrated circuit (ASIC), a field programmable gated array (FPGA) or the like. In some embodiments, sensor/data module 212 can communicate directly with other remote sensors or edge devices directly or through a network using communications module 214. In some embodiments, sensor/data module 212 may be a sensing module as described with respect to FIG. 1 (e.g., sensing modules 130-138). In some embodiments, sensor/data module 212 may receive data from real-time data sources as described with respect to FIG. 1 (e.g., real-time data sources 148).

In some embodiments, computing device 200 may communicate with other devices and/or components of a power system using communications module 214. In some embodiments, the communications module 214 may include a network interface cards (NIC), modems, antennas, and other elements typically used for communications, whether wired or wireless. The communications module 214 can utilize one or more communication technologies, such as USB, infrared, Bluetooth™, or the like. The communications module 214 can also utilize any suitable communications protocol (e.g., DNP3, Modbus, TSN, TCP/IP, OpenFMB, etc.) to communicate with other devices.

In some embodiments, computing device 200 may coordinate or synchronize operation with other devices and components using coordination module 216. In some embodiments, computing device 200 may form part of an array of devices configured to act as a single system. In those embodiments, computing device 200 may coordinate with the other devices using coordination module 216. In some embodiments, the coordination module 216 may implement any suitable communication protocol to communicate with the other devices. In an embodiment, the coordination module 216 communicates with the other devices using communications module 214.

According to an embodiment, the computing device 200 includes a mass memory module 220 in communication the processing module 202. The mass memory module 220 may include a random-access memory (RAM), a read-only memory (ROM), and other storage means. The mass memory module 220 illustrates another example of computer storage media for storage of information such as computer readable instructions, data structures, program modules or other data. In some embodiments, the mass memory module stores a basic input/output system (BIOS) for controlling low-level operation of computing device 200. The mass memory module 220 can also store an operating system for controlling the operation of computing device 200.

Mass memory module 220 may further include one or more data stores, which can be utilized by computing device 200 to store, among other things, applications 222 and/or other information or data. For example, data stores may be employed to store information that describes various capabilities of computing device 200. At least a portion of the capability information may also be stored on a disk drive or other storage medium (not shown) within computing device 200. Applications 222 may include computer executable instructions which, when executed by computing device 200, transmit, receive, and/or otherwise process audio, video, images, and enable telecommunication with a server and/or another device. In some embodiments, applications 222 may include the power system model. In some embodiments, the power system model may be stored in mass memory module 220.

While not shown, computing device 200 may also include other modules or elements. According to some embodiments, computing device 200 may include a power supply, an audio interface, a display, a keypad, an illuminator, a haptic interface, and a camera(s) or other optical, thermal or electromagnetic sensor. Power supply provides power to computing device 200. Computing device 200 can include one camera/sensor, or a plurality of cameras/sensors, as understood by those of skill in the art. The audio interface is arranged to produce and receive audio signals such as the sound of a human voice. The display(s) may be a liquid crystal display (LCD), gas plasma, light emitting diode (LED), or any other type of display used with a device. The display (s) may also include a touch sensitive screen arranged to receive input from an object such as a stylus or a digit from a human hand. The keypad may comprise any input device arranged to receive input from a user. The illuminator may provide a status indication and/or provide light. The haptic interface is arranged to provide tactile feedback to a user of the device.

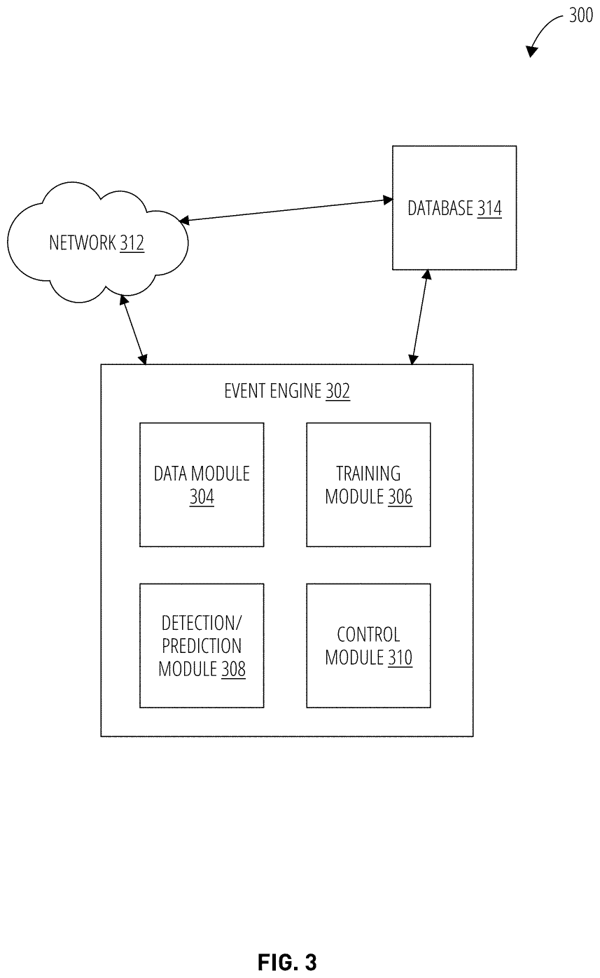

Turning now to FIG. 3, a block diagram illustrating the components for performing the systems and methods discussed herein. FIG. 3 includes event engine 302, network 312 and database 314. The event engine 302 can be a special purpose machine or processor and could be hosted by a cloud server (e.g., cloud web services server(s)), application server, content server, web server, user's computing device, and the like, or any combination thereof.

According to some embodiments, event engine 302 can be embodied as a stand-alone application that executes on a computing device. In some embodiments, the event engine 302 can function as an application installed on computing device, for example, circuit protection device 102 and computing device 200 discussed above in relation to FIG. 1 and FIG. 2, respectively. In some embodiments, such application can be a web-based application accessed by the computing device over a network. In some embodiments, portions of the event engine 302 function as an application installed on the computing device and some other portions can be cloud-based or web-based applications accessed by the computing device over a network, where the several portions of the event engine 302 exchange information over the network. In some embodiments, the event engine 302 can be installed as an augmenting script, program or application (e.g., a plug-in or extension) to another application or portal data structure.

The database 314 can be any type of database or memory, and can be associated with a content server on a network (e.g., content server or application server) or a computing device (e.g., circuit protection device 102 or computing device 200). In an embodiment, database 314 may comprise a dataset of data and metadata associated with devices and components of a power system.

In some embodiments, such information can be stored and indexed in the database 314 independently and/or as a linked or associated dataset. As discussed above, it should be understood that the data (and metadata) in the database 314 can be any type of information and type, whether known or to be known, without departing from the scope of the present disclosure.

According to some embodiments, database 314 can store data for components, e.g., performance characteristics, parameters, limits, ratings, historical operational data, real-time operational data, operational states, configuration, and topology data. According to some embodiments, the stored data can include, but is not limited to, images, videos, audio, logs, maintenance records, operational cycles, faults, environmental conditions, weather records, social media data, device specifications, and the like, or some combination thereof. It should be understood that the data (and metadata) in the database 314 can be any type of information related to a power system, a component, a device, an application, a service provider, or a user, whether known or to be known, without departing from the scope of the present disclosure.

In an embodiment, database 314 may comprise a training dataset including a collection of labeled media and other records corresponding to a power system. In some embodiments, the domain specific training dataset is used to train a power system model. In some embodiments, the power system model is a machine learning model. In some embodiments, the power system model comprises at least one neural network. In some embodiments, the power system model is stored in the database 314 in a known model format (e.g., .raw, .seq, and .dyr) as used by Siemens® PTI power system simulator application. According to some embodiments, database 314 can store data for the power system model including a circuit model, a protection model, and a controls model.

The network 312 can be any type of network such as, but not limited to, a wireless network, a local area network (LAN), wide area network (WAN), the Internet, or a combination thereof. In some embodiments, the network 312 facilitates connectivity of the event engine 302, and the database 314. Indeed, as illustrated in FIG. 3, the event engine 302 and database 314 can be directly connected by any known or to be known method of connecting and/or enabling communication between such devices and resources.

The principal processor, server, or combination of devices that comprise hardware programmed in accordance with the special purpose functions herein is referred to for convenience as event engine 302, and includes data module 304, training module 306, detection/prediction module 308, control module 310. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

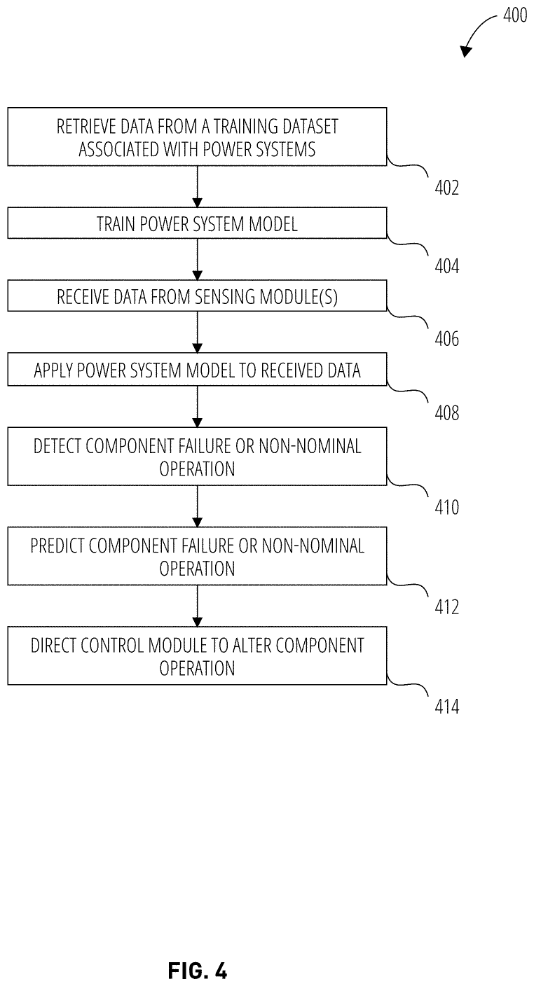

Turning to FIG. 4, process 400 details non-limiting embodiments for performing scalable detection and mitigation of component failure or non-nominal operation. Process 400 of FIG. 4 begins with Step 402 where data module 304 of event engine 302 retrieves a piece of data from a training dataset associated with a state of a power system or component in a power system from a database (e.g., database 314). In some embodiments, the training dataset is related to many power systems. In some embodiments, the training dataset includes historical data associated with a specific power system or power systems in general (e.g., a domain). As noted elsewhere, historical data can include images, videos, audio, logs, maintenance records, operational cycles, faults, environmental conditions, weather records, social media data, device specifications, and the like, or some combination thereof. In some embodiments, the training dataset contains data associated with a performance characteristic or an operational state of a component in a power system. For example, in some embodiments, the training dataset may include thermal images associated with an inverter overload. For example, in some embodiments, the training dataset may include weather data associated with voltage drops at specific components. For example, in some embodiments, the training dataset may include audio recordings of exploding transformers on transmission lines associated with customer reports of loss of service or damaged devices. For example, in some embodiments, the training dataset may include auto-ranging meter logs related to an appliance failure.

For purposes of this disclosure, the retrieving data from Step 402 will be in regard to a single piece of data for clarity of explanation purposes, as one of ordinary skill in the art would readily recognize the applicability of engine 302's performance of process 400 (and its sub-steps) to many different types of data without departing from the scope of the instant disclosure.

In step 404, the event engine 302 trains a power system model using training module 306 by propagating the retrieved data through the power system model, predicting a state of the power system based on the retrieved data, comparing the output of the power system model to the expected output associated with the retrieved data, and updating the power system model based on the difference between the two. In some embodiments, step 404 may include using a loss function to update the power system model. In some embodiments, the power system model includes traditional power system models including legacy protection curves and functions, and the like. In some embodiments, step 404 the event engine 302 starts with a generic power system model and creates a specific power system model using component lists, topology data, configuration settings, and the like. In some embodiments, the output of Step 404 is a trained power system model.

In Step 406, the event engine 302 receives real-time data (e.g., from real-time data sources 148) and sensing data (e.g., from sensing modules 130-138) associated with components of the trained power system model. As noted elsewhere, in some embodiments, sensing data may include at least one performance characteristic of a component in the power system. In some embodiments, the sensing data may include an operational state of the component. In Step 408, the event engine 302 applies the trained power system model to the received real time data/sensing data.

In some embodiments, in Step 410, event engine 302 may detect a component failure, non-nominal operation of a component, and/or abnormal behavior in the power system using detection/prediction module 308. In some embodiments, in Step 412, the power system model may predict future or existing component failure, non-nominal operation of a component, and/or abnormal behavior in the power system based on the historical data and the real-time data/sensing data using detection/prediction module 308.

In Step 414, event engine 302 may direct or control a component, a plurality of components, or parts thereof to change at least one of a component behavior, a performance characteristic, and an operational state. In some embodiments, process 400 may return to Step 404 to update the trained power system model.

According to some embodiments, in a non-limiting example a protection device (e.g., circuit protection device 102 or computing device 200) receives data from a remote camera monitoring a portion of a transmission line or structure in the transmission path. For example, the data may contain images or video of a tree falling on the transmission line or structure. The received image or video is then provided to the power system model to predict an operational state of the transmission line (e.g., a bolted fault, a ground fault, a phase-to-phase fault, or a high impedance fault). Then, in some embodiments, the predicted operational state may be correlated with the initial contact of object with conductor through seeding of current and voltage fluctuations at feeder, recloser, or sectionalizing switchgear of the power system to identify potentially affected portions or components. In some embodiments, if these correlate, then one or more control modules may be directed to trip or disconnect the identified portions or components to isolate fault or open phase with the least protection zone exposure (e.g., number of components of the power system exposed to or affected by the fault(s)) for isolation. In some embodiments, data gathered during the incident (e.g., from the time the tree fell to the time the fault was isolated and corrected), including, but not limited to, data from sensors and affected components, may be used to create a training database to train a machine learning model (e.g., power system model). In some embodiments, data related to the event may be include data from a period of time before and after the incident (e.g., 2 hours before and after). In some embodiments, data from other sensors (e.g., acoustic or thermal) may correlated with the data from the imaging sensor so that the power system model may recognize a similar incident from an incident signature including data from one or more sensors. For example, in some embodiments, a power system model may be trained to recognize an incident (e.g., a tree falling in a transmission model) from acoustic and thermal data based on incidents recorded using visual-range imaging data.

As noted elsewhere, in some non-limiting examples, an incident may be detected based on data from any number of sources. In some non-limiting examples, data may include current, voltage, thermal, vision, temperature, acoustics, geographic information systems (e.g., Esri), and open-source data from governmental and private entities (e.g., traffic alerts, outage alerts, and real-time lightning data).

According to some embodiments, data gathered or received by a protection device as described herein (e.g., circuit protection device 102 or computing device 200) may be used to characterize an incident (e.g., lightning strikes on transformers, downed power lines, equipment tampering, malfunctioning equipment, etc.) on a power system. In an embodiment, a protection device uses thermal imaging to detect a fault and identified the malfunctioning component(s). While the protection device only used thermal imaging data to detect the fault and the component(s), the protection device may associate other data received simultaneously from other sources with the incident. Then, in some embodiments, the additional data may be used to re-train or further train the power system model to improve the model's performance (e.g., precision, recall, loss, and the like). In some embodiments, some or all the data collected or received with respect to an incident may be used to determine a fault signature, a failure signature, or a non-nominal performance signature of the power system or of a component of the power system.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

What is claimed is:

1. A system comprising:
a sensing module designed to determine at least one performance characteristic of a component of a power system, the sensing module further configured to transmit the at least one characteristic;
a processing module operatively connected to the sensing module, the processing module configured to receive the at least one characteristic and apply a power system model to the at least one characteristic to determine at least one operational state of the component; and
a control module operatively connected to the processing module, the control module configured to effect a change in at least one of the component and another component of the power system in response to the at least one operational state.

2. The system of claim 1, wherein the sensing module includes at least one of voltage/current meters, current transformers, potential transformers, transducers, cameras, and microphones; and the at least one performance characteristic is at least one of voltage, current, load, temperature, and cycles.

3. The system of claim 1, wherein the power system model is a trained power system model trained using a training dataset including historical data of the power system.

4. The system of claim 1, wherein the at least one operational state is an overload, an underload, a short circuit, and overheating.

5. The system of claim 1, the processing module further configured to receive real-time data from at least one real-time data source and apply the power system model to the received real-time data to determine at least one other operational state of the component.

6. The system of claim 5, wherein the at least one real-time data source includes at least one of real-time images, video, and sounds; weather and environmental data; anecdotal/observational human reports; and social media data.

7. The system of claim 5, the control module further configured to effect a change in the at least one of the component and another component of the power system in response to the at least one other operational state.

8. The system of claim 1, wherein the control module includes circuit breakers, switchgear, reclosers, disconnects, interrupters, tap changers, circuit switchers, and switches.

9. A method comprising:
receiving, from a sensing module designed to determine at least one performance characteristic of a first component of a plurality of components of a power system, the at least one performance characteristic;
applying, using a processing module, a power system model to the at least one characteristic to determine at least one operational state, the power system model corresponding to the power system; and
directing, a control module operatively connected to at least one of the first component and a second component of the plurality of components, to effect a change in the at least one of the first and second components in response to the at least one operational state.

10. The method of claim 9, wherein the sensing module includes at least one of voltage/current meters, current transformers, potential transformers, transducers, cameras, and microphones; and the at least one performance characteristic is at least one of voltage, current, load, temperature, and cycles.

11. The method of claim 9, wherein the control module includes circuit breakers, switchgear, reclosers, disconnects, interrupters, tap changers, circuit switchers, and switches.

12. The method of claim 9, wherein the at least one operational state is an overload, an underload, a short circuit, and overheating.

13. The method of claim 9, further comprising:
receiving, from a real-time data source, real-time data associated with at least one of the first component, the second component, and a third component of the plurality of components;
applying, using the processing module, the power system model to the received real-time data to determine at least one other operational state; and
directing the control module to effect a change in the at least one of the first, second, and third components in response to the determined at least one other operational state.

14. The method of claim 13, wherein the at least one real-time data source includes at least one of real-time images, video, and sounds; weather and environmental data;
anecdotal/observational human reports; and social media data.

15. The method of claim 9, wherein the power system model is a trained power system model, the method further comprising:
retrieving, from a database, a training dataset including historical data associated with at least one historical operational state of the power system;
applying, using the processing module, the power system model to the historical data;
determining, using the processing module, a predicted operational state of the power system based on the historical data; and
updating, using the processing module, the power system model based on a deviation between the predicted operational state and the at least one historical operational state to create the trained power system model.

16. A non-transitory computer-readable storage medium for tangibly storing computer program instructions capable of being executed by a computer processor of a computing device, the computer program instructions defining steps of:
receiving, from a sensing module designed to determine at least one performance characteristic of a first component of a plurality of components of a power system, the at least one performance characteristic;
applying, using a processing module, a power system model to the at least one characteristic to determine at least one operational state, the power system model corresponding to the power system; and
directing, a control module operatively connected to at least one of the first component and a second component of the plurality of components, to effect a change in the at least one of the first and second components in response to the at least one operational state.

17. The non-transitory computer-readable storage medium of claim 16, wherein the sensing module includes at least one of voltage/current meters, current transformers, potential transformers, transducers, cameras, and microphones; and the at least one performance characteristic is at least one of voltage, current, load, temperature, and cycles; wherein the control module includes circuit breakers, switchgear, reclosers, disconnects, interrupters, tap changers, circuit switchers, and switches; and wherein the at least one operational state is an overload, an underload, a short circuit, and overheating.

18. The non-transitory computer-readable storage medium of claim 16, the computer program instructions further defining steps of:
receiving, from a real-time data source, real-time data associated with at least one of the first component, the second component, and a third component of the plurality of components;
applying, using the processing module, the power system model to the received real-time data to determine at least one other operational state; and
directing the control module to effect a change in the at least one of the first, second, and third components in response to the determined at least one other operational state.

19. The non-transitory computer-readable storage medium of claim 18, wherein the at least one real-time data source includes at least one of real-time images, video, and sounds; weather and environmental data; anecdotal/observational human reports; and social media data.

20. The non-transitory computer-readable storage medium of claim 16, wherein the power system model is a trained power system model, the computer program instructions further defining steps of:
retrieving, from a database, a training dataset including historical data associated with at least one historical operational state of the power system;
applying, using the processing module, the power system model to the historical data;
determining, using the processing module, a predicted operational state of the power system based on the historical data; and
updating, using the processing module, the power system model based on a deviation between the predicted operational state and the at least one historical operational state to create the trained power system model.
